(19) United States
(12) Patent Application Publication
(10) Pub. No.: US 2005/0130741 A1
(43) Pub. Date: Jun. 16, 2005

(54) Human power conversion system based on video game play with exercise bicycle

(76) Inventor: Raj Pandian, Ann Arbor, MI (US)

Correspondence Address: Theresa A. Orr;BUTZEL LONG, Suite 200, 100 Bloomfield Hills Parkway, Bloomfield Hills, MI, 48304, US

(21) Appl. No.: 10/988,949

(22) Filed: Nov. 15, 2004

Related U.S. Application Data
(63) Continuation-in-part of application No. 10/369,081, filed on Feb. 18, 2003.

(51) Int. Cl. G06F 17/00; G06F 19/00

(52) U.S. Cl. 463/36

(57) ABSTRACT

The invention is based on the use of pneumatic systems for the conversion of human power of children's play. The energy of the compressed air can then be converted to electricity for purposes such as lighting and communication. This provides a low-cost, low-resource means of generation of electricity, especially for use in developing countries. This embodiment is an extension of the invention by generating electricity from the pedaling action of an exercise bicycle while playing a video game and includes the use of a stationery exercise bicycle, a video gaming system, a monitor, a game controller including buttons/joystick on the bicycle, electromechanical and biomedical sensors, an artificial intelligence-based pre-processor for signals from the controller, and a pneumatic or electromechanical energy conversion device for producing electricity. The electricity produced can be used to quantify the play or exercise involved, and to provide incentives to encourage sustained play or exercise.

### CROSS-REFERNCE TO RELATED APPLICATIONS

This application is a continuation-in-part of U.S. application Ser. No. 10/369,081, filed on Feb. 18, 2003 and entitled Pneumatic Human Power Conversion System Based on Children's Play.

### TECHNICAL FIELD

The invention described in “Pneumatic Human Power Conversion System based on Children's Play” is based on the use of pneumatic (i.e., compressed air) systems such as cylinders, motors, valves, and regulators for the conversion of human power of children's play in school playgrounds and other public places. The energy of the compressed air can then be converted to electricity for purposes such as lighting and communication. This provides a low-cost, low-resource means of generation of electricity, especially for use in developing countries.

The present invention is an extension of this invention by combining video game play with an exercise bicycle for conversion of human power into electricity. The invention includes the use of a stationary exercise bicycle, a video gaming system, a television or computer monitor, a game controller including buttons/joystick on the bicycle, electromechanical and biomedical sensors, an artificial intelligence-based pre-processor for signals from the controller, a pneumatic or electromechanical energy conversion device for producing electricity, a signal conditioner to quantify the exercise done, and a recording/printing device to provide incentives proportionate to the exercise. Children and adults can play games, individually or in groups, on the console by pedaling and isometric exercise, and the power conversion subsystem produces electricity in excess of the energy used to operate the overall system.

The system can be used in homes and schools, public playgrounds, athletic clubs, video game arcades, and places like fast-food restaurants and shopping centers to encourage children and adults to indulge in physical activity combined with the entertainment of video gaming. The system can also be combined with educational software. The power produced can be used as a backup power source—especially in developing countries—as well as a quantitative measure of physical activity with a view to providing incentives or rewards to people to exercise actively.

### BACKGROUND OF THE INVENTION

The use of pedal power and exercise machines to generate electricity for powering appliances is nearly a century old, as discussed by Seelhorst and McCullagh. A patent for a device that generates electricity from stationary bicycle for viewing television was issued to Holmes in 1981 (U.S. Pat. No. 4,298,893). More recently, this method has been used by some engineer-volunteers to provide Internet access to a village in Laos without electric supply (Applewhite). Pedal power has been harnessed through pneumatic means by Tsukagoshi et al as an emergency power source during earthquakes.

Several inventors have proposed the combination of exercise machines and video games over the years. In U.S. Pat. No. 4,512,567, an exercise bicycle is used in conjunction with a video game, the control signals to the game being provided by pedal speed sensors and handle bar motion sensors. Action switches are also attached to the handle bar for input to the video game.

U.S. Pat. No. 4,711,447 presents a similar exercise apparatus with inputs to the video game provided by the pedal and handle bar motions. Further, the chair and assembly positions are fed back, and mechanical friction elements are used for user adjustment of the exertion levels.

A combination exercise and video game system is proposed in U.S. Pat. No. 5,362,069, in which in addition to motion sensors the heart rate signal is measured and fed back to modify the exertion level of the game.

Jarvis (U.S. Pat. No. 5,577,981) developed a virtual reality exercise system with a fixed support frame and movable components with which exercises were provided to the user by employing a video system. Jarvis employs a video camera as well as position and force sensors for supplying real-world information to the virtual reality (VR) system.

Ohsuga, et al (U.S. Pat. Nos. 5,997,439 and 6,244,987) have invented VR exercise systems for wellness therapy. In '439, for bed-ridden patients the virtual reality environment is modified by physiological and psychological measurements. In '987, a range of stimuli are provided such as sight, hearing, touch, and smell in the control of the VR environment.

Recently, a commercial game controller called Kilowatt for the Xbox, PS2, and PC games has become available. It is essentially a game pad providing isometric exercise for the player while playing video games with commercial consoles (Hermida).

Initially, the present invention was developed for the purpose of harnessing the collective energy of a number of children to create a large power output sufficient for continuous operation of several lights, fans, and communication equipment for a long time. The premise being that the power is produced as part of play and therefore separate, deliberate effort is not required to produce power. The proposed approach involves low cost: a clockwork radio producing a few watts of power generally costs $50 or more. For the cost of a few hundred dollars, the hardware for the play-based power harvesting system could produce several hundreds of watts of electricity.

The invention is eminently suited to developing countries where the main constraints are cost, ruggedness, and low-resource and skill requirements (cf. piezoelectric or storage capacitors). A natural extension of this invention is to harness such power indoors by combining video game play with exercise bicycles.

Several inventions have sought to combine exercise systems with the entertainment aspect of video games as well as advanced technologies like virtual reality. These inventions have the advantage of reducing the monotony of repetitive exercise and make it fun and entertaining. Some inventions have also combined video gaming with physical therapy in order to reduce the drudgery of therapy to disabled persons.

Use of pedal power from stationery bikes to produce electricity was proposed nearly a century ago. In the early part of the 20^{th} century, pedal power was used in remote locations to produce electricity to watch television. Other forms of human power conversion have been proposed in recent years, e.g., hand cranking to power radio, flash lights, and cell phones, and foot wear fitted with power conversion devices to operate wearable computers and portable electronics.

While all the above inventions require deliberate effort and produce limited amounts of electricity, this invention of a pneumatic human power conversion was proposed based on children's play. The novelty of this invention is that it does not require deliberate effort and produces significantly more amounts of power, sufficient to operate appliances. Electromechanical alternatives to the pneumatic power conversion subsystem were also proposed.

These playful energy converters are based on outdoor playground equipment where the children are stationery with respect to the equipment, e.g., seesaw, swing, and merry-go-round. A drawback to this invention is that reliable operation of the outdoor play equipment requires expensive weatherproofing and the children's play depends on favorable weather conditions.

By contrast, pedal power conversion produces more power, is more efficient, can be done indoor with simple power conversion apparatus, and can also involve exercise activity by adults. However, continuous operation of the bicycle over a long period is felt to be monotonous by both children and adults. Therefore, as an extension of the original invention, it is sought to extend the playful energy conversion idea to the case of combination of pedal power conversion accompanied by video game play.

### SUMMARY OF THE INVENTION

The present invention combines the pedal power-based electricity generation method with the video gaming technique, to develop a source of significant amounts of electric power both as a source of energy and as a measure of physical exercise to provide incentives to the participants.

The artificial intelligence-based pre-processor for signals from the game controller is a crucial part of the new invention. The reaction times for video games with the exercise system will not be as fast and sustained as for the hand-operated conventional controllers, due to the physical exertion involved. Moreover, where persons of different physical capacities participate in multi-player games (e.g., parents and children, or bigger and smaller children), the smaller or younger players will be at a disadvantage.

Therefore, in the general case the pre-processor will be used to “speed up” the responses of the players before the controller commands are sent to the game console. For multi-player games with players of unequal physical capabilities, the pre-processor can be used to “equalize” the commands from the individual controllers in a fair manner so as to render the gamers competitive. Of course, this amounts to using software to “cheat” the game software; however, the main goal of the invented system is not video gaming per se, but to use the entertainment element of video gaming to sustain physical exercise and power generation.

If the pre-processor is provided with visual information on the progress of the game, then it can actively assist the player in the game. Otherwise, the processing of the signals from the game controller will mainly be anticipatory and heuristic. However, custom-made video game software for the system can be specifically designed taking into considerations knowledge of optimal exercise patterns and energy expenditure patterns for the players. In this case, the game software will modify the progress of the game (e.g., make it easier to win) so as to encourage the player to exercise to the utmost extent.

The intelligent pre-processor can also be used in a “learning” mode for specific participants; either based on input information (such as name or age and weight) or sensed information such as weight of the participants (using force sensors attached to the bike seat). In this mode, the pre-processor would then modify the command signals sent to the console or modify the mechanical impedances interfaced to the user so as to sustain a preferred pattern of exercise over a short-term or long-term period.

The advantages of the extended invention are manifold:

1. It can produce more power compared to the outdoor playful human power converters based on teeter totter, swing, and merry-go-round and is also more efficient being based on video game play on stationary bicycle.

2. Both adults and children can use it, e.g., parents can play with their children on multiple bikes and game controllers connected to a single console-monitor system.

3. Since off-the-shelf video game software can be readily used with the proposed invention, continued operation of the system over long periods of time can be achieved because of the entertainment value of the video game.

4. Motivation to indulge in exercises is increased by cooperation or competition from partners-in-training. Therefore, at homes, schools, and other public places, multi-player video gaming based on the proposed invention can lead to increased participation in exercises. This will lead to better physical fitness in the long run and reduce obesity.

5. Educational personal computer software for children shares many similarities with video games. Therefore, the proposed invention can also be implemented in conjunction with educational software, to combine both physical and learning activities.

6. While the pedal power system is most suited for games such as racing, it can also be combined with other types of games (e.g., fights or battles) by combination with passive (e.g., springs or dampers) and active (e.g., actuators with variable impedance elements) mechanical devices.

7. In the context of developed countries where energy is available abundantly and at affordable prices, the electricity produced can be used mainly as a quantitative measure of physical activity and thereby to provide incentives or rewards to children and youth to exercise, e.g., in schools, video game arcades, shopping centers and fast food restaurants. On the other hand, in the developing countries the invention can be used in schools and other pubic places as a source of back-up power to operate basic appliances such as lights, fans.

### BRIEF DESCRIPTION OF THE DRAWINGS

FIG. 1 illustrates a preferred embodiment of the present invention wherein the energy conversion is compressed air energy storage based on a seesaw using an air motor.

FIG. 2 illustrates a continuation of the system in FIG. 1 showing the transmission of compressed air to power generator and showing the power generation from compressed air.

FIG. 3 illustrates a preferred embodiment of the present invention wherein the energy conversion is compressed air energy storage based on a seesaw using a slider-crank mechanism.

FIG. 4 illustrates a preferred embodiment of the present invention wherein the energy conversion is compressed air energy storage based on a swing using a pneumatic rotary actuator.

FIG. 5 illustrates a preferred embodiment of the present invention wherein the energy conversion is compressed air energy storage based on a merry-go-round using an air motor.

FIG. 6 illustrates a preferred embodiment of the present invention wherein the energy conversion is compressed air energy storage based on a merry-go-round using a crank-slider mechanism.

FIG. 7 illustrates a preferred embodiment of the present invention wherein the energy conversion is based on a seesaw using an electromagnetic generator.

FIG. 8 illustrates a preferred embodiment of the present invention wherein the energy conversion is based on a swing using an electromagnetic generator.

FIG. 9 illustrates a preferred embodiment of the present invention wherein the energy conversion is based on a merry-go-round using an electromagnetic generator.

FIG. 10 illustrates a preferred embodiment of the present invention wherein the energy conversion is of the electromechanical type based on a stationary bike on which the player exercises while playing a video game on the console.

### DESCRIPTION OF THE PREFERRED EMBODIMENT

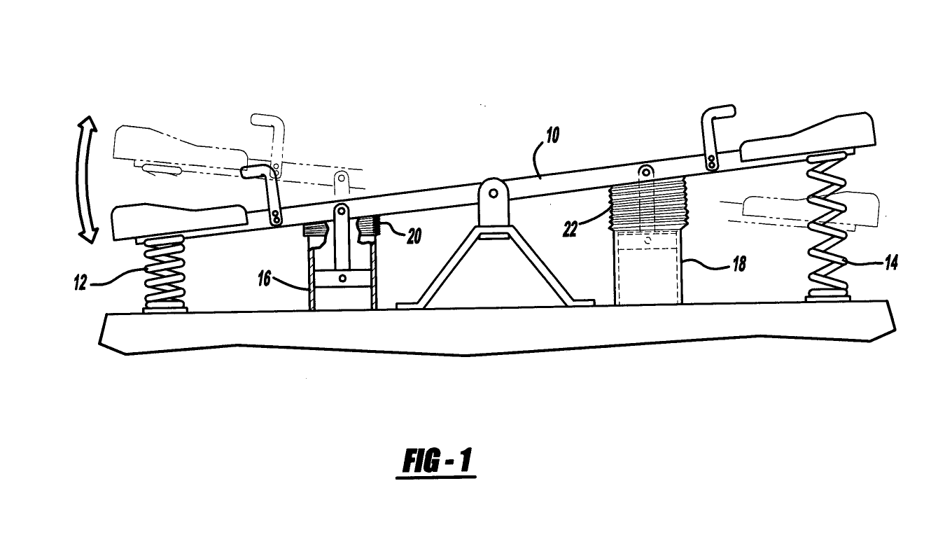

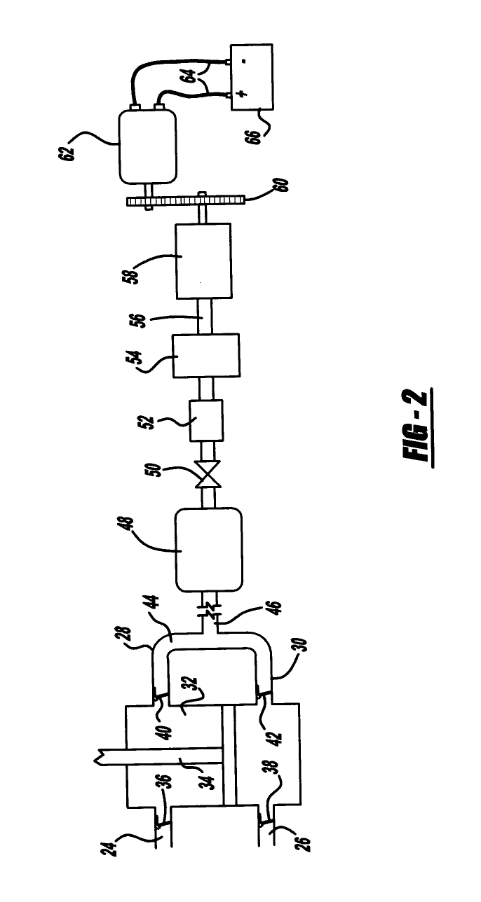

FIGS. 1 and 2 illustrate the basic principle of the new invention. For simplicity, we limit our discussion to power conversion based on a seesaw. The cases of a swing and a merry-go-around can be considered similarly.

In FIG. 1, the seesaw 10 is often supplied with hard cylindrical helical springs 12, 14 to smoothen the actions of the seesaw mechanism. In the present mechanism, instead of the springs we employ two pneumatic cylinders 16, 18 on the two sides of the seesaw. To prevent any accidents and injuries to players' limbs from the moving pistons, we provide a bellows-type flexible sheath between the bottom of seesaw and the top of the cylinder as shown 20, 22. The outer bodies of the cylinders would get heated due to the compression of air inside. This would require shielding of the outer bodies too (not shown here).

To simplify the system and make it portable, the bottom end of the cylinders can also be fixed to the central support of the seesaw, rather than being fixed to the ground.

FIG. 2 shows the process of compression of air and its transmission to the power generator stage. For improved compression rate, we consider the case of double acting cylinder. The atmospheric air enters the cylinder input ports 24, 26 alternately through check (or plate) valves 36, 38. The reciprocating vertical motion of the piston 34 of the cylinder 32 under the motion of the seesaw results in compressed air being outputted through check valves 40, 42 via output ports 28, 30 to the pipeline through a union tee joint 44. Reference numeral 46 indicates that the pipeline could be very long. The compressed air from the pipeline is stored in an air tank 48. Essential parts of the air tank, such as pressure gage, pressure release valve, regulator, etc are not shown here for simplicity.

When the compressed air inside the air tank reaches a set pressure level, the on-off valve 50 is opened. The air is passed through a filter-regulator-lubricator unit 52. If the pressure of the stored air is low due to pressure drop along long pipeline, then an air booster 54 can be used to reduce the volume and increase the pressure of the air to the power generator unit.

FIG. 2 also illustrates the generation of power from the compressed air. The compressed air from the pipeline 56 is used to actuate an air motor 58. The electric generator 62 is coupled to the air motor 58 through a gear train 60. The resulting motion of the electric generator produces an electric current through the cables 64, which is used to charge the battery 66.

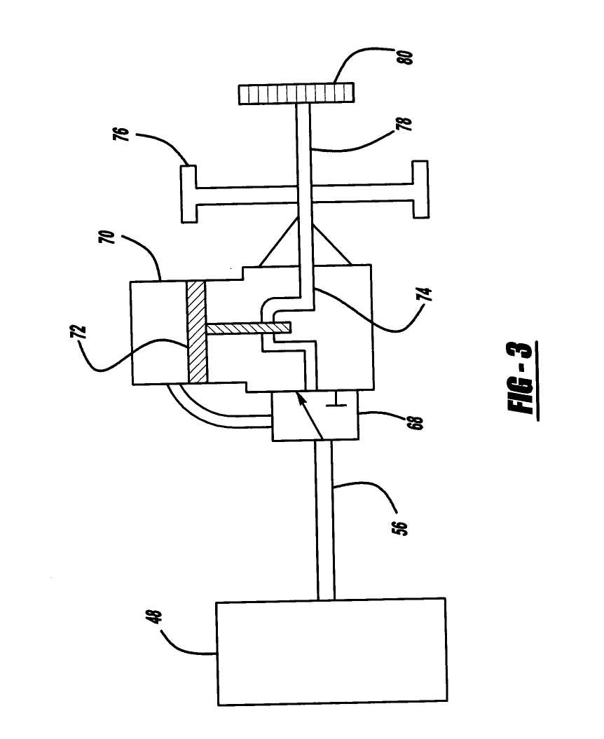

In general, air motors are very expensive compared to air cylinders and moreover require extensive gearing. Therefore, to reduce cost we can simply use compressed air from the pipeline 56 to actuate a cylinder which in turn can be used with a slider-crank mechanism to move the electric motor. The operation of this mechanism is shown in FIG. 3.

Here, compressed air from air tank 48 is fed through pipeline 56 to an intake/exhaust valve 68 driven by crank shaft 74. For simplicity, the components shown in FIG. 2, viz., on-off valve and filter-regulator-lubricator unit are not shown here.

The compressed air drives a piston 72 housed in a cylinder 70 and attached to the crank shaft 74. A flywheel 76 is attached to the output shaft 78 of the crank shaft. A gear train 60 is connected at the end of the output shaft, and an electric generator-battery-wires combination as shown in FIG. 2 is used to generate electricity.

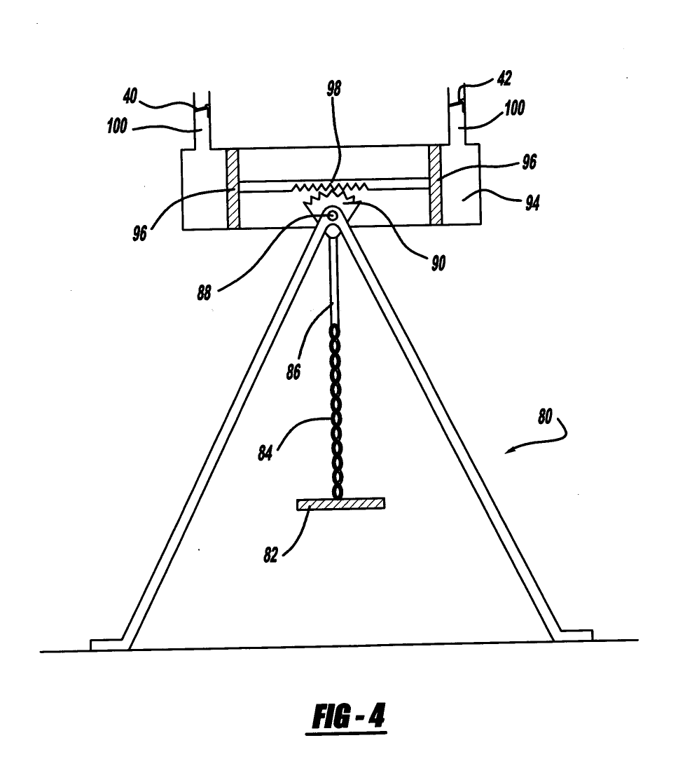

In the case of harnessing human power of children playing on a swing, a pneumatic rotary actuator can be used as the compression mechanism. FIG. 4 illustrates this case. Here, a rigid arm 86 is connected through a swing pivot 88 to the top cross bar of the swing 80. The swing seat 82 is connected to the rigid arm 86 through the flexible chain 84. The use of the rigid arm allows the capture of a large portion of the torque of the swing's movement. The top end of the rigid arm 86 is fitted with a sector gear 90, which is connected to a rack gear 98 connected between the pistons 96 housed inside a cylinder 94. Two actuators are used, one at each end of the swing.

The rotational movements of the swing during children's play result in compression of air in the two closed chambers of the cylinder. The compressed air is released to the storage and power conversion section through output ports 100 under the control of check valves 40 and 42. The compressed air storage and power conversion sections are similar to those shown in FIG. 2 for the use of an air motor.

Here again, rotary actuators are expensive and therefore a pinion-and-rack gearing mechanism can be used to actuate a double acting cylinder for compression of air. The mechanism shown in FIG. 3 may be used for this purpose.

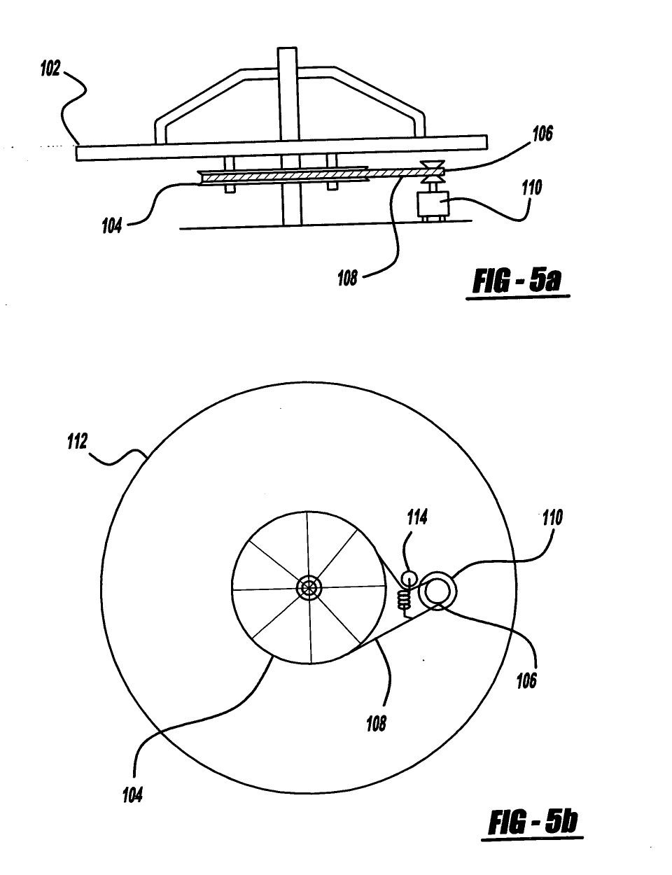

Air motors could be used in the case of merry-go-rounds for compression. FIG. 5 illustrates this case. In the top view, the merry-go-round is shown transparent for clarity. A large diameter drive pulley 104 is connected to the bottom of the rotating disk 112 of the merry-go-round 102. A V-belt 108 moves along the drive pulley 104 due to the rotation of the merry-go-round. The V-belt passes over a motor pulley 106 whose shaft is connected to the air motor 110. A tensioner pulley with spring 114 is used to maintain the torque on the air motor.

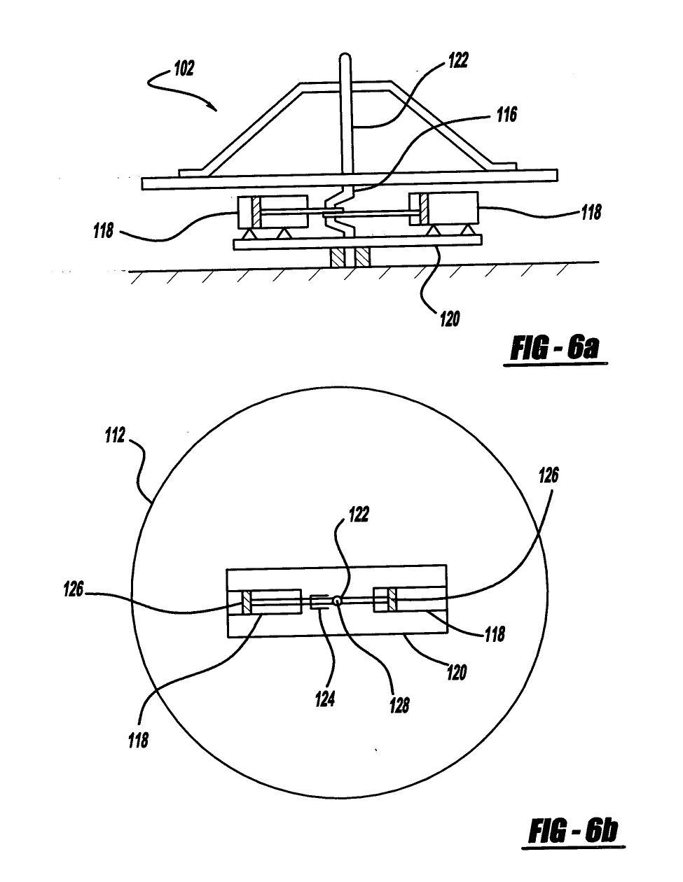

Here too, due to cost considerations it will be preferable to use crank-slider mechanism (as used in positive displacement reciprocating piston-type compressors) with an air cylinder. FIG. 6 illustrates this case. Here, two double-acting cylinders 118 are mounted on a support platform 120 below the rotating disk 112 of the merry-go-round 102. A crank 124 is attached to the bottom of the center post 116. Two cylinders are used with their pistons 126 connected to the crank 124 through connecting rod 128 to the center post 122.

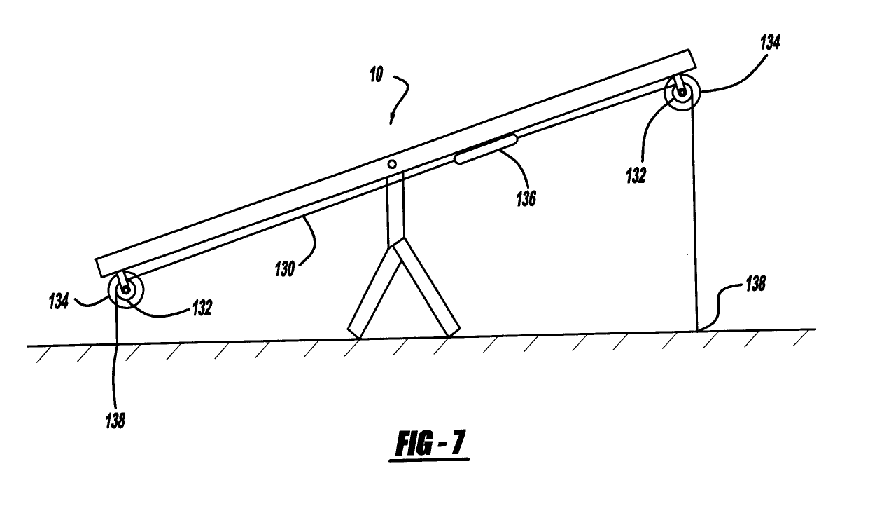

FIG. 7 illustrates the use of electromagnetic generators to harness the power children's play on the seesaw 10. A cable 130 runs through pulleys 132 attached to the bottom of the seesaw at the ends. The cable is wound once the simple pulleys to ensure friction. Further, a spring 136 is used with the cable to maintain tension in the cable. Gear motors 134 are coupled to the shaft of the pulleys and the cable ends are anchored to the ground at 138.

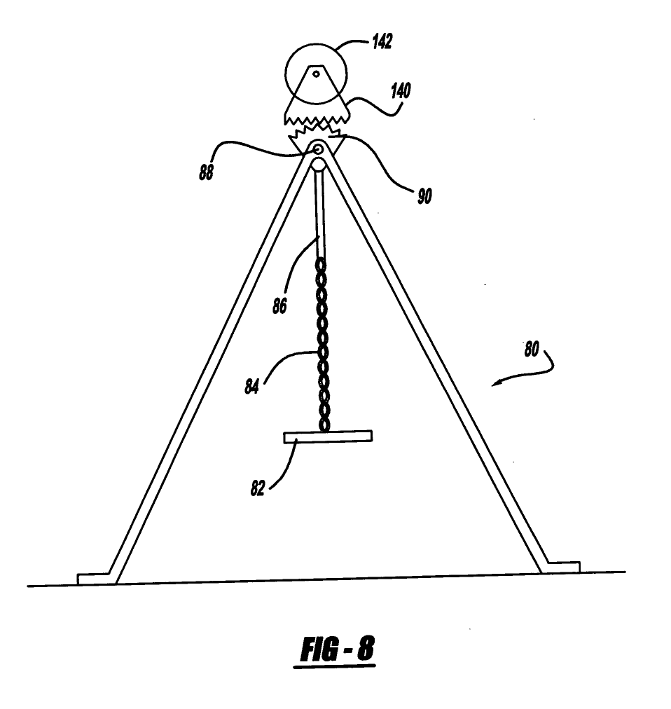

The use of electromagnetic generator to convert the power from the swing is illustrated in FIG. 8. As in the pneumatic conversion case (shown in FIG. 4), the sector gear 90 is used, coupled to the rigid arm 86. A gear motor 142 is coupled to the shaft of the upper gear.

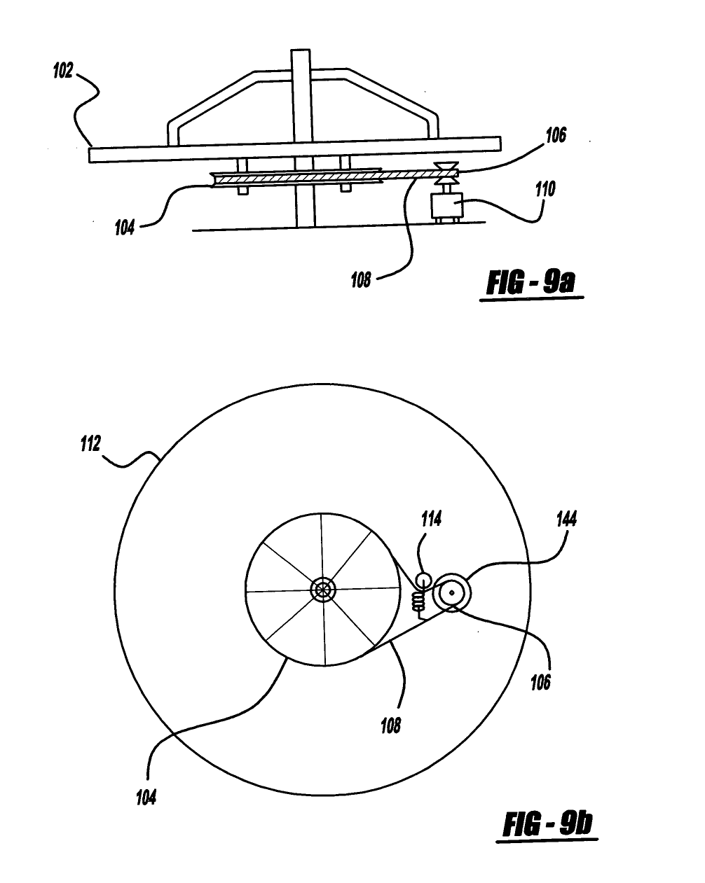

FIG. 9 illustrates the use of electromagnetic generator in connection with a merry-go-round. The mechanism is identical to the case of pneumatic conversion with air motor (shown in FIG. 5), except that a gear motor 144 acting as a generator replaces the air motor.

The up and down motion of the seesaw, and the to and fro motion of the swing results in alternately positive and negative voltage to be generated at the terminals of the gear motors, which acts as a generators. Therefore, an ac-to-dc rectifier will be used to generate a dc voltage for charging the battery (not shown for simplicity).

To reduce maintenance and improve the performance, it is necessary to filter the air entering the compressing cylinders. This is particularly so because air in the playground atmosphere is dust-filled. However, coarse air filters may be sufficient in most cases unlike in precision industrial operation. In practice, trade-offs between cost of air filters and cost of maintenance of low-cost cylinders may also be considered.

Finally, it may be mentioned that human power conversion is easily achieved from children's play under conditions where the children are static relative to the moving mechanism such as seesaw. Where the children are in a dynamic state relative to a static mechanism (e.g., slide) it will be difficult, though not impossible, to employ human power conversion techniques due to considerations of safety and simplicity.

The main alternative to the present pneumatic approach for human power conversion based on children's play would be to use electric (i.e., electromagnetic) generators. This method has the advantage of higher energy efficiency. However, as mentioned before it is constrained by the hazards of electric shock and leak hazards in children's playgrounds or meeting places. In fact, pneumatic motors are preferred over electric motors in applications such as opening and closing of aquarium tank doors for this same reason.

Minor variations of the pneumatic approach could also be implemented in practice: e.g., use mini gas turbines run by compressed air to move electric generators. However, for the kind of low-pressure energy storage system considered here, the reciprocating cylinder-type system is more economical and simpler to use.

Other approaches to producing renewable electricity for schools would be to install solar panels or wind turbines. However, the costs of these techniques would be far higher than those for the proposed invention.

In recent years, energy use/scarcity has become a serious problem due to depletion of non-renewable energy sources, increasing population, environmental pollution, and Global Warming. While in developed countries, the energy problem is one of short-term scarcity or optimum use, an estimated 40% of the world's population—or, 2 billion people in the less developed countries—do not have even have access to electricity. Moreover, this number is expected to double by the year 2050.

While the costs of solar, wind, geothermal, etc energy generation are coming down gradually, they are still beyond the reach of people in many developing countries, where majority of the population earns per capita incomes of less than a dollar a day. They do not have access to capital, technology, and resources such as oil, coal, or nuclear material. Even where there is an electricity grid, long-duration power outs are very common, particularly in summer when the rivers run dry.

Therefore, the invention outlined here could be used in playgrounds to provide very low-cost electric power for basic needs such as lighting, fans, and communication. The technology of compressed air involved is fairly simple, and well within the skills of technicians in developing countries. The material requirements are also fairly minimal: cylinders (variant of bicycle pumps could be used), valves, rubber or PVC pipelines, low-cost pressure gages and regulators, etc. The systems can easily be maintained and upgraded or repaired.

The use of the new technology also offers two significant side-benefits to children in developing countries: first, the promise of low-cost guaranteed electric power would encourage the introduction of reasonably well-equipped, safe and ergonomically designed play equipment in their schools and meeting places. Secondly, use of air filters as part of the compressed air systems could help reduce some of the air pollution in their school/background environments. The hybrid pneumatic-gasoline car invented by Guy Negre is similarly being adopted in high-pollution cities in Mexico and other developing countries because it acts as a negative emission vehicle, using atmospheric air for compression through on-board air filters.

Future modifications of the new invention also will have potential applications in a hi-tech setting, e.g. as a power source for wearable computing, emergency power source during earthquakes, and power assist for the elderly and handicapped.

Theoretical and experimental studies can be conducted to optimize the design of the proposed system, e.g., sizing of components, location of play equipment, etc.

The present invention has fairly limited application in developed countries where cheap and abundant electric power is readily available. The main potential for this invention lies in developing countries, where electricity supply is non-existent, erratic, or expensive.

The technology behind the new invention could be deployed on a wide scale in developing countries, with the manufacturing of the systems by local companies. Labor and materials will be a major part of the expenses involved, and local conditions would have a significant influence on the installation and running of the final systems in schools and playgrounds.

The proposed systems can also be used for play by children at homes, contributing an alternative source of power.

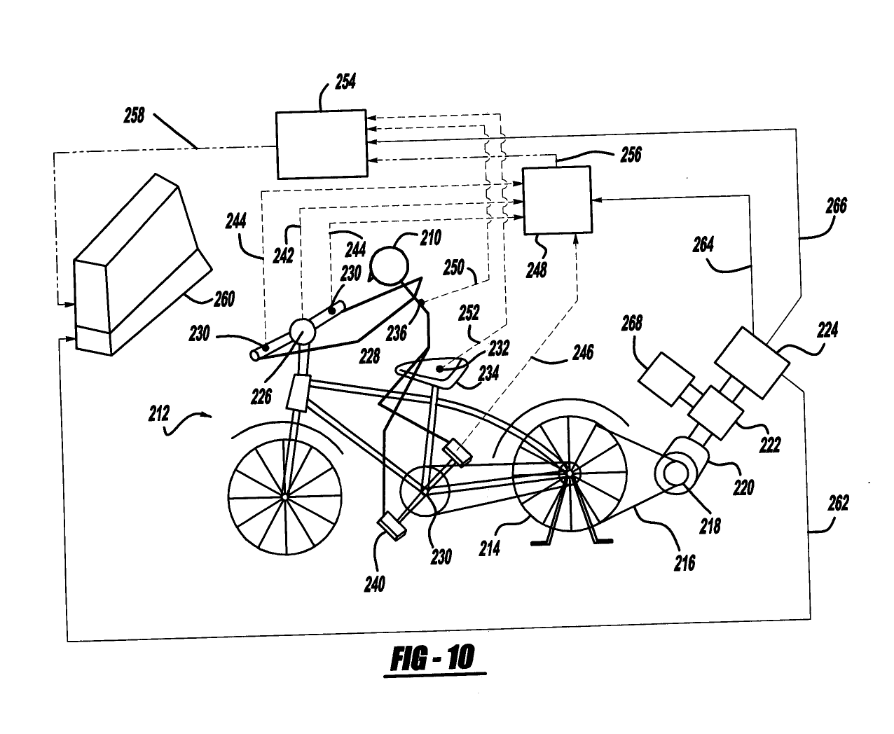

In FIG. 10, the player 210 pedals on a stationary bike 212. The rear wheel is free to rotate, and with the tire removed the wheel rim 214 can be used as a large diameter pulley. A v-belt 216 moves along the rim 214 due to the rotation of the wheel under the pedaling action. The v-belt 216 passes over a motor pulley 218 whose shaft is connected to a gear motor 220. The fixed attachment of the motor-pulley combination is not shown for simplicity. As is well known in the art, a tensioner pulley with spring can be used to maintain tension in the v-belt.

The electricity produced in the motor 220—acting here as a generator—is measured by a signal conditioner 222 and used to charge a battery 224. Occasionally, the player 210 will be required to pedal in reverse. In this case, if the rim 214 is arranged so as to move in reverse, an electric voltage of opposite polarity will be produced. This voltage can either be blocked out using a diode, or a rectifier can be used to reverse its polarity before charging the battery.

A potentiometer 226 is attached to the center of the handle bar 228, to sense the left or right turn angle of the handle bar 228. Action buttons 230 are attached at either end of the handle bar 228. The player 210 presses on them either intermittently or continuously during play. A force sensor 232 is attached to the bike's seat 234 so that the weight of the player 210 can be estimated using suitable signal conditioning circuitry. A heart beat sensor 236 is also used, and a rotary encoder 238 is attached to the shaft of the pedal 240. The encoder 238 is used to estimate the speed, direction and forward/reverse displacement of the pedaling.

Thus, the sensors 232, 236, and the action buttons or switches 230 are used to simulate the joystick and buttons on the conventional game controller. The signals: 242 from the potentiometer 226, 244 from the action switches 230, and 246 from the rotary pedal encoder 238 are fed to the game controller 248. The signals 250 from the heart beat sensor 236, and 252 from the force or weight sensor 232 are fed to the intelligent pre-processor 254. The game controller's command signals 256 are first fed to the intelligent pre-processor 254, which sends the modified command signals 258 to the video game console 260.

The battery 224 supplies the power 262 necessary to operate the game console 260, the power 264 to operate the game controller 248, and the power 266 to operate the pre-processor 254. To ensure uninterrupted operation or immediate start of the game, either a back-up battery or ac power can be used. The recording/printing device 268 connected to the signal conditioner 222 is used to provide incentives to the players, e.g., storing the generated power levels in a data logger or printing out tokens corresponding to the power generated.

The emulation of the basic video game system in the above manner is most suited for games such as racing. It can also be combined with other types of games (e.g., fights or battles) by combination with passive (e.g., springs or dampers) and active (e.g., actuators with variable impedance elements) mechanical devices (not shown here for simplicity).

Although the invention has been described with particular reference to certain preferred embodiments thereof, variations and modifications can be effected within the spirit and scope of the following claims.

1. A method for producing power from the pedaling action of an exercise bicycle while playing a video game comprising the steps of:
providing a stationary bicycle having at least one freely rotating wheel;
using said freely rotating wheel as a pulley for transferring rotation of said wheel via a belt to a motor pulley;
generating electricity from a motor attached to said motor pulley;
charging a battery electrically connected to said motor; and
operating a video game console with the power supplied from the battery.

2. The method of claim 1, and further comprising the steps of:
providing said stationary bicycle with at least one sensor; and
mimicking a conventional game controller through signals fed from said sensor to a game controller electrically connected to said video game console.

3. The method of claim 1, and further comprising the steps of:
providing said stationary bicycle with at least one switch; and
mimicking a conventional game controller through signals fed from said switch to a game controller electrically connected to said video game console.

4. The method of claim 3, wherein said stationary bicycle further comprises a handlebar and said at least one switch is located along said handlebar for activation by a user, said switch mimicking an action switch of a conventional game controller.

5. The method of claim 4, wherein said handlebar further comprises a potentiometer electrically connected to said game controller and comprising the steps of:
sensing a left or right turn angle of said handlebar by said game controller; and
feeding said sensed turn angle through said potentiometer as a command signal by said game controller to said video game console via an intelligent pre-processor.

6. The method of claim 2, and further comprising the steps of:
locating said at least one sensor on the seat of said bicycle, wherein said sensor is a force sensor;
sending a signal from said seat force sensor first to an intelligent pre-processor, said signal indicating the estimated weight of a user; and
said pre-processor modifying said game controller's command signal to send a command signal to said video game console to reflect the estimated weight of said user proportionately.

7. The method of claim 2, and further comprising the steps of:
locating said at least one sensor on the user of said bicycle, wherein said sensor is a heart beat sensor;
sending a signal from said heart beat sensor first to an intelligent pre-processor, said signal indicating the estimated heart beat of a user; and
said pre-processor modifying said game controller's command signal to send a command signal to said video game console to reflect the estimated heart beat of said user proportionately.

8. A method for producing power from the pedaling action of an exercise bicycle while playing a video game comprising the steps of:
providing a stationary bicycle having at least one freely rotating wheel;
using said freely rotating wheel as a pulley for transferring rotation of said wheel via a belt to a motor pulley;
generating electricity from a motor attached to said motor pulley;
charging a battery electrically connected to said motor;
operating a video game console with the power supplied from the battery;
quantifying the physical activity of the user using the said electricity generated; and
providing incentives to the user proportionately to the exercise done through rewards for the said electricity generated.

9. The method of claim 8, and further comprising the steps of:
providing said stationary bicycle with at least one sensor;
mimicking a conventional game controller through signals fed from said sensor to a game controller electrically connected to said video game console;
sending a signal from the said motor to a signal conditioner to quantify the physical activity of the user;
sending a signal from the said signal conditioner to a recording/printing device; and
said recording/printing device providing incentives to the user proportionately to the exercise done through rewards for the said electricity generated.

10. The method of claim 8, and further comprising the steps of:
providing said stationary bicycle with at least one switch; and
mimicking a conventional game controller through signals fed from said switch to a game controller electrically connected to said video game console.

11. The method of claim 10, wherein said stationary bicycle further comprises a handlebar and said at least one switch is located along said handlebar for activation by a user, said switch mimicking an action switch of a conventional game controller.

12. The method of claim 11, wherein said handlebar further comprises a potentiometer electrically connected to said game controller and comprising the step of:
sensing a left or right turn angle of said handlebar by said game controller; and
feeding said sensed turn angle through said potentiometer as a command signal by said game controller to said video game console via an intelligent pre-processor.

13. The method of claim 9, and further comprising the steps of:
locating said at least one sensor on the seat of said bicycle, wherein said sensor is a force sensor;
sending a signal from said seat force sensor first to an intelligent pre-processor, said signal indicating the estimated weight of a user; and
said pre-processor modifying said game controller's command signal to said video game console to reflect the estimated weight of said user proportionately.

14. The method of claim 9, and further comprising the steps of:
locating said at least one sensor on the user of said bicycle, wherein said sensor is a heart beat sensor;
sending a signal from said heart beat sensor first to an intelligent pre-processor, said signal indicating the estimated heart beat of a user; and
said pre-processor modifying said game controller's command signal to said video game console to reflect the estimated heart beat of said user proportionately.

15. A method for producing power from pedaling action while playing a video game comprising the steps of:
providing a stationary bicycle having at least one freely rotating wheel;
using said freely rotating wheel as a pulley for transferring rotation of said wheel via a belt to a motor pulley;
generating electricity from a motor attached to said motor pulley;
charging a battery electrically connected to said motor;
operating a video game console with the power supplied from the battery;
measuring the physical activity of the user; and
providing a source of back-up power to operate basic appliances.

16. The method of claim 15, and further comprising the steps of:
providing said stationary bicycle with at least one sensor; and
mimicking a conventional game controller through signals fed from said sensor to a game controller electrically connected to said video game console.

17. The method of claim 15, and further comprising the steps of:
providing said stationary bicycle with at least one switch; and
mimicking a conventional game controller through signals fed from said switch to a game controller electrically connected to said video game console.

18. The method of claim 17, wherein said stationary bicycle further comprises a handlebar and said at least one switch is located along said handlebar for activation by a user, said switch mimicking an action switch of a conventional game controller.

19. The method of claim 18, wherein said handlebar further comprises a potentiometer electrically connected to said game controller and comprising the step of:
sensing a left or right turn angle of said handlebar by said game controller; and
feeding said sensed turn angle through said potentiometer as a command signal by said game controller to said video game console via an intelligent pre-processor.

20. The method of claim 16, and further comprising the steps of:
locating said at least one sensor on the seat of said bicycle, wherein said sensor is a force sensor;
sending a signal from said seat force sensor first to an intelligent pre-processor, said signal indicating the estimated weight of a user; and
said pre-processor modifying said game controller's command signal to said video game console to reflect the estimated weight of said user proportionately.

21. The method of claim 16, and further comprising the steps of:
locating said at least one sensor on the user of said bicycle, wherein said sensor is a heart beat sensor;
sending a signal from said heart beat sensor first to an intelligent pre-processor, said signal indicating the estimated heart beat of a user; and
said pre-processor modifying said game controller's command signal to said video game console to reflect the estimated heart beat of said user proportionately.

22. The method of claim 15, and further comprising the step of:
converting said power to implement educational learning software with said video game consol.
